(19) United States
(12) Patent Application Publication
(10) Pub. No.: US 2026/0213619 A1
(43) Pub. Date: Jul. 23, 2026

(54) ARRANGEMENT AND METHOD FOR REQUIREMENT-BASED DISTRIBUTION OF COOLING/LUBRICATING OIL FLOWS IN ELECTRIC TRACTION DRIVES

(71) Applicant: MAGNA Powertrain GmbH & Co KG, Lannach (AT)

(72) Inventors: Wolfgang SCHWEIGER, St. Stefan (AT); Matthias PFAU, Koeln (DE)

(21) Appl. No.: 19/139,992

(22) PCT Filed: Dec. 5, 2023
(86) PCT No.: PCT/EP2023/084371

§ 371 Date: Jun. 17, 2025

(30) Foreign Application Priority Data
Dec. 23, 2022 (DE) 10 2022 214 389.2

(51) Int. Cl. H02K 9/19; F16N 13/04; F16N 13/06; F16N 25/00

(52) U.S. Cl. CPC H02K 9/19; F16N 13/04; F16N 13/06; F16N 25/00; F16N 2013/063; F16N 2210/18; F16N 2270/70

(57) ABSTRACT

The invention relates to an arrangement for the requirement-based distribution of cooling/lubricating oils in electric traction drives with an electrically controllable motor pump unit and a hydraulic arrangement, wherein the motor pump unit can be controlled in both rotational directions, and wherein the motor pump unit is connected via a heat exchanger to several fluid outlets for partial volume flows which are connected at least to the stator of an electric machine, the rotor of an electric machine and the transmission for cooling and/or heating and/or lubrication, wherein at least one fluid outlet is additionally opened via at least one hydraulically switchable valve when the rotational direction of the motor pump unit is reversed.

### CROSS-REFERENCE TO RELATED APPLICATIONS

This application is a National Stage of International Application No. PCT/EP 2023/084371, filed Dec. 5, 2023, which claims priority to DE 10 2022 214 389.2, filed Dec. 23, 2022. The entire disclosures of each of the above applications are incorporated herein by reference.

### FIELD

The invention relates to an arrangement and a method for requirement-based distribution of cooling/lubricating oil flows in electric traction drives with an electrically controllable motor pump unit and a hydraulic arrangement, wherein the motor pump unit can be activated in both directions of rotation, and wherein the motor pump unit is connected via a heat exchanger to a plurality of fluid outlets which are connected at least to the stator of an electric machine, to the rotor of an electric machine, and to the transmission for cooling and/or heating and/or lubrication purposes.

### BACKGROUND

Partly or completely oil-cooled electric machines are used in high-powered electric drives with a high energy density. The rotor shaft and/or the stator of the electric machine are cooled here with oil. In the case of completely oil-cooled electric machines, the cooling oil requirement of the rotor shaft and the stator varies—depending on the respective operating point—in particular owing to the copper, iron, and electromagnetic losses which occur in the machine. Requirement-based allocation of the partial volume flows to the rotor shaft and the stator is thus required for the highest possible thermal availability and for minimizing the loss of power.

Known solutions use passive, pressure- or temperature-controlled valves as described in DE 102017101826 A1. The use of active, electrically activatable switching or proportional valves is also possible but is usually avoided for cost reasons.

A disadvantage of the use of passive, pressure-or temperature-controlled valves is the influence of manufacturing and component tolerances and a usually large hysteresis within the working range. Active influencing of the switching behavior is impossible or possible only in a limited fashion. For example, such influencing of pressure-controlled valves can be effected by increasing or lowering the rotational speed of the pump motor for a short period of time, as a result of which, however, the volume flow delivered is also influenced. The ability for fine regulation is not possible and instead discrete switching valve behavior is consequently implemented.

The use of active, electrically controllable switching or regulating valves entails high costs for the valves and for the electrical integration and is usually avoided for cost reasons.

Oil pumps which are driven by means of brushless direct-current motors (BLDC motors) are usually used which, independently of the speed of the vehicle, supply a delivered volume flow which can be set as required by regulating the rotational speed of the BLDC motor. Rotating positive-displacement pumps designed as a ring-gear pump or gerotor pump are used as the preferred type of pump. The gerotor pump consists of a set of gears with an inner rotor and an outer rotor and a pump housing which generally has a two or three-part design. This inherently simple and well-established design nevertheless entails high costs for the motor pump unit, in particular for the BLDC motor and the required commutation electronics, such as a BLDC driver or B6 bridge circuit, for controlling the motor.

DE 10 2017 113 057 A1 concerns a coolant delivery module for a transmission, preferably an automatic transmission. There is an electrically controllable motor pump unit which cannot, however, be activated in both directions of rotation. A connection via a heat exchanger is present. However, the partial flows do not serve to cool or heat or lubricate the stator of an electric machine. They also are not used to cool a rotor. This prior art is a solution with a complex valve structure.

The document DE 10 2019 100 872 A1 concerns the cooling and lubrication of an electric hybrid drive via a fluid outlet. In a first direction of rotation of the pump, a heat exchanger is supplied via a line with fluid which then performs all the cooling and lubrication tasks via suitable lines. In the second delivery direction, pressure is applied to either the clutch or the parking brake via a line 1. Although the document uses a motor which can reverse its direction of rotation and fulfils different tasks in the two directions of rotation, this is very complex to implement.

The document DE 32 10 759 A1 concerns quantity regulation via a pump having multiple pump stages or via multiple pumps. It cannot be deduced from this document that the partial volume flow to the stator or to the winding heads comprises the majority of the volume flow.

The document DE 10 2018 007462 A1 describes a solution with a pump with two pump outlets, wherein the outlets are used to cool and lubricate a transmission.

DE 10 2009 038 377 A1 shows a hydraulic arrangement for activating a plurality of clutches with a regulatable torque distribution device. A high-pressure subcircuit with pressure accumulators for actuating the clutch with associated switchable valves is present here. The cooling of the oil of the clutch is performed on the low-pressure side, wherein a switchable valve pulses the oil flow.

DE 102013224667 A1 shows a hydraulic arrangement with regulatable valves such that the regulation can be effected in different operating modes with different working principles or regulating parameters.

The object of the invention is to utilize the second direction of rotation of the motor pump unit via additional simple hydraulic stop valves in order to create functional added value and enable the requirement-based supply of the cooling oil flows to the rotor shaft and stator of the electric machine.

It is intended here that there is no or only a minimal increase in costs compared with the known prior art and at the same time an equivalent or improved control of the partial volume flows is achieved.

### SUMMARY

The object is achieved by an arrangement for requirement-based distribution of cooling/lubricating oil flows in electric traction drives with an electrically controllable motor pump unit and a hydraulic arrangement, wherein the motor pump unit can be activated in both directions of rotation, and wherein the motor pump unit is connected via a heat exchanger to a plurality of fluid outlets which are connected at least to the stator of an electric machine, to the rotor of an electric machine, and to the transmission, wherein at least one fluid outlet is additionally opened via at least one hydraulically switchable valve when a reversal of the direction of rotation of the motor pump unit takes place.

The arrangement according to the invention is largely independent of the motor pump unit used. Only a piston-ported positive displacement pump and a bidirectionally operatable motor are needed. The positive displacement pumps are designed as axial piston pumps, radial piston pumps, vane pumps, roller cell pumps, or gerotor pumps. All these pumps are regularly piston-ported, i.e. they have a suction port on the suction side and a discharge port on the discharge side, wherein the use of a suction port ensures a good suction capacity. The port control system makes a simple structure of the pump possible.

The motor pump unit which is part of the system is extended by simple and inexpensive hydraulic valves, stop valves, as a result of which bidirectional operation of the pump is possible. Different volume flow distributions, fixedly defined via hydraulic resistance control, can thus be achieved in the right-hand and left-hand rotation of the pump. Any desired distributions within the fixed allocations can furthermore be achieved at fluid outlets by intermittent reverse operation over time. This is effected exclusively in the software by corresponding modulation of the rotational speed and period in the right-hand and left-hand rotation of the motor pump unit.

A cost advantage can thus be obtained with the solution according to the invention compared with the use of electrically actuatable switching or proportional valves. Functional added value can be obtained by precise and fully active control of the partial volume flows compared with the use of passively actuatable, thermally controlled valves by the removal of tolerance and hysteresis influences.

It is advantageous that partial volume flows are available for the electric traction drive via the fluid outlets, wherein the partial volume flow to the stator or to the winding heads of the stator comprises the majority of the volume flow.

Presetting of the partial volume flows can be effected via diaphragms.

The hydraulically switchable valve is a hydraulically openable nonreturn valve or a hydraulically actuatable 2/2-way valve or a hydraulically controllable proportional valve.

The hydraulic arrangement is constructed from a plurality of housing plates, wherein the housing plates carry in each case at least one functional unit.

The functional units comprise at least one of the valves and/or radially arranged bores opening into peripheral annular grooves.

The object is achieved by a method for requirement-based distribution of cooling/lubricating oil flows in electric traction drives with an electrically controllable motor pump unit and a hydraulic arrangement, wherein the motor pump unit is activated in both directions of rotation, and wherein the motor pump unit is connected via a heat exchanger to a plurality of fluid outlets which are connected at least to the stator of an electric machine, to the rotor of an electric machine, and to the transmission, wherein at least one fluid outlet is additionally opened via at least one hydraulically switchable valve when a reversal of the direction of rotation of the motor pump unit takes place.

It is advantageous that different operating modes are set in order to set the flow volume of the respective partial volume flows at the fluid outlets, wherein in a reverse-operation operating mode a switch is made cyclically between the directions of rotation of the motor pump unit over time.

Different operating modes from operation of the motor pump unit in a direction of rotation A or a direction of rotation B or in reverse operation can thus be set.

Additional rotational-speed-dependent activation of the motor pump unit is provided.

The following advantages result from the solution according to the invention:

The invention allows the requirement-based control of partial volume flows in order to increase the efficiency and/or thermal availability of electric drive systems with a completely or partially oil-cooled electric machine.

The hydraulically activated valves allow precise control of the partial volume flows with no additional electrical energy requirement.

The solution is largely independent of the motor pump unit used and compatible with existing motor and pump components.

The arrangement can have a robust construction by virtue of the use of simple hydraulic stop valves and an intelligent operating strategy.

A high degree of flexibility is afforded by the possibility of adapting the partial volume flows in the software.

The desired maximum degree of efficiency and/or thermal availability can be obtained—depending on the operating state—by the combination with intelligent, self-learning functional software.

Because the hydraulic valves can be integrated completely in the region of the pump head, for example by virtue of the housing plate construction illustrated, a very high degree of compatibility can be afforded with the platform concept or with the requirement to use common modules.

### BRIEF DESCRIPTION OF THE DRAWINGS

FIG. 1 shows the hydraulic circuit diagram of a first embodiment of the arrangement with a stop valve,

FIG. 2 shows the operating modes which can be implemented with the first embodiment,

FIG. 3 shows by way of example a qualitative progression of the volume flow,

FIG. 4 shows the hydraulic circuit diagram of a second embodiment of the stop-valve arrangement,

FIG. 5 shows the hydraulic circuit diagram of a third embodiment of the stop-valve arrangement,

FIG. 6 shows the hydraulic circuit diagram of a fourth embodiment of the stop-valve arrangement,

FIG. 7 shows the hydraulic circuit diagram of a further embodiment for requirement-based distribution of cooling/lubricating oil flows,

FIG. 8 shows the operating modes which can be implemented with the arrangement illustrated in FIG. 7,

FIG. 9 shows a qualitative illustration of the values which are relevant for the reversal of the direction of rotation in the reversing procedure,

FIG. 10 shows by way of example a method for the requirement-based distribution of cooling/lubricating oil flows in an electric traction drive,

FIG. 11 shows an isometric view of an embodiment of the arrangement illustrated in FIG. 1,

FIG. 12 shows a further isometric view of the embodiment according to FIG. 11,

FIG. 13 shows a front view of the embodiment according to FIGS. 11 and 12,

FIG. 14 shows, in order to illustrate the hydraulic flow path, the corresponding negative geometry of the embodiment illustrated in FIGS. 11-13,

FIG. 15 shows an isometric view of a second embodiment of the arrangement illustrated in FIG. 1,

FIG. 16 shows a front view of FIG. 15,

FIG. 17 shows a side view of the embodiment illustrated in FIG. 15,

FIG. 18 shows a view in section along the plane of section A-A illustrated in FIG. 16,

FIG. 19 shows a view in section along the plane of section B-B illustrated in FIG. 17,

FIG. 20 shows an isometric view of FIG. 15,

FIG. 21 shows an isometric view of a first housing plate,

FIG. 22 shows an isometric view of a swivel flap valve,

FIG. 23 shows an isometric view of the first housing plate,

FIG. 24 shows an isometric view of the first housing plate.

### DETAILED DESCRIPTION

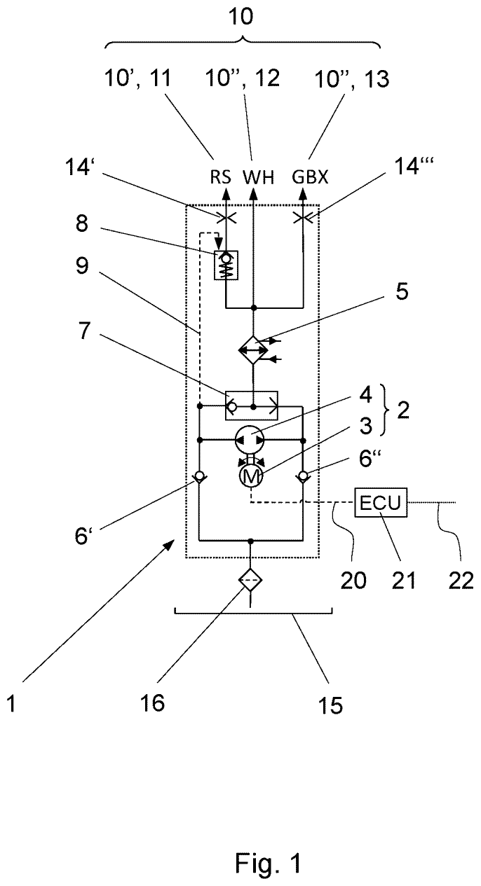

FIG. 1 shows a hydraulic circuit diagram of an arrangement 1 for requirement-based control of partial volume flows 10 with a stop valve arrangement in a first embodiment. A coolant lubricating pump 4 is driven by an electric motor 3 which can rotate in both directions of rotation. The two components form an electrically controllable motor pump unit 2. The coolant lubricating pump 4 is connected to an oil sump 15 on the suction side and the discharge side via a first nonreturn valve 6′and a second nonreturn valve 6″. Depending on the direction of rotation of the pump, one of the two nonreturn valves 6′, 6″ is situated in an open position and the in each case other nonreturn valve in a stop position. The connection to the oil sump is effected via a sieve or filter element 16 arranged in between.

The whole delivered volume flow supplied by the pump 3 is thus at all times routed via a shuttle valve 7 and a heat exchanger 5. In the direction of rotation A, a hydraulically controlled stop valve 8 is situated in a stop position. The whole delivered volume flow is thus allocated at individual fluid outlets between the stator WH, 12 and the transmission GBX, 13. Specifically, the allocation of the partial volume flows 10″ and 10′″ to the fluid outlets is made via a diaphragm 14′″ arranged in the inflow to the transmission.

In the direction of rotation B, the hydraulically controlled stop valve 8 is opened via a pump pressure prevailing in a control line 9. The whole delivered volume flow is thus allocated between the rotor RS, 11, the stator WH, 12, and the transmission GBX, 13. The desired allocation of the partial volume flows 10′, 10″, 10′″ is made analogously to the operation in the first direction of rotation A—via a further diaphragm 14′ arranged in the inflow to the rotor 11.

Any desired allocations of the volume flow into partial volume flows, within the fixedly defined distributions for right-hand and left-hand rotation of the motor pump unit, can be implemented by intermittent reverse operation.

The largest partial volume flow 12 is routed in each operating mode 26 and with no additional throttling to the stator WH, 12. This enables an energy-efficient allocation of the remaining smaller partial volume flows 11, 13 via hydraulic resistance control. This hydraulic resistance control is preferably implemented by means of perforated diaphragms with defined flow cross sections. A largely viscosity-and thus temperature-independent allocation of the partial volume flows 10′, 10″, 10′″ can be implemented as a result.

Activation is effected via an electrical control unit 21 which is connected to a data bus 22. The control unit 21 is connected to the motor 3 of the motor pump unit 2 via an electrical line 20.

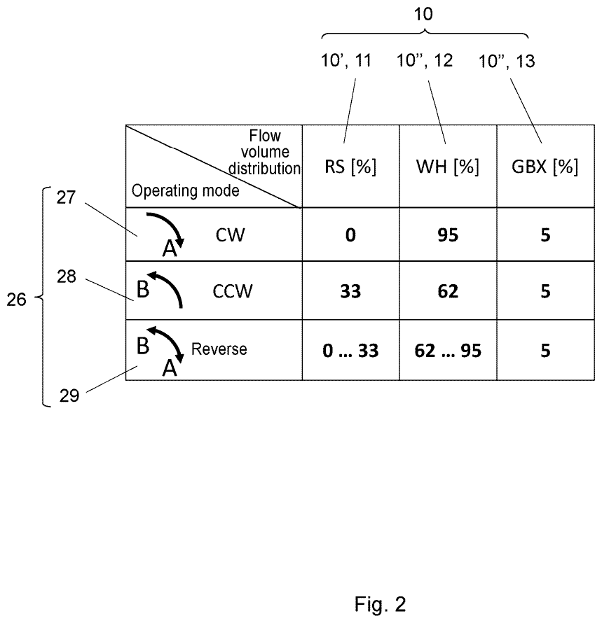

FIG. 2 shows the operating modes 26 which can be implemented with the arrangement illustrated in FIG. 1, and an exemplary volume flow allocation for a first direction of rotation 27, the direction of rotation A, a second direction of rotation 28, the direction of rotation B, and for the reverse operation 29 of the motor pump unit 2. The allocation illustrated refers in each case to the whole delivered volume flow supplied by the pump 3.

The nominal design of the allocation of the partial volume flows in the direction of rotation A and in the direction of rotation B is fixed for two operating states with different cooling oil requirements, for example for operating points with a high drive torque or for operating points at high rotational speed. The nominal design is such that a good allocation in the first direction of rotation 27, the direction of rotation A, or in the second direction of rotation 28, the direction of rotation B, is provided for the majority of the operating points. Furthermore, any desired intermediate distributions can be implemented by alternating operation of the motor pump unit in the direction of rotation A and in the direction of rotation B, the so-called reverse operation 29.

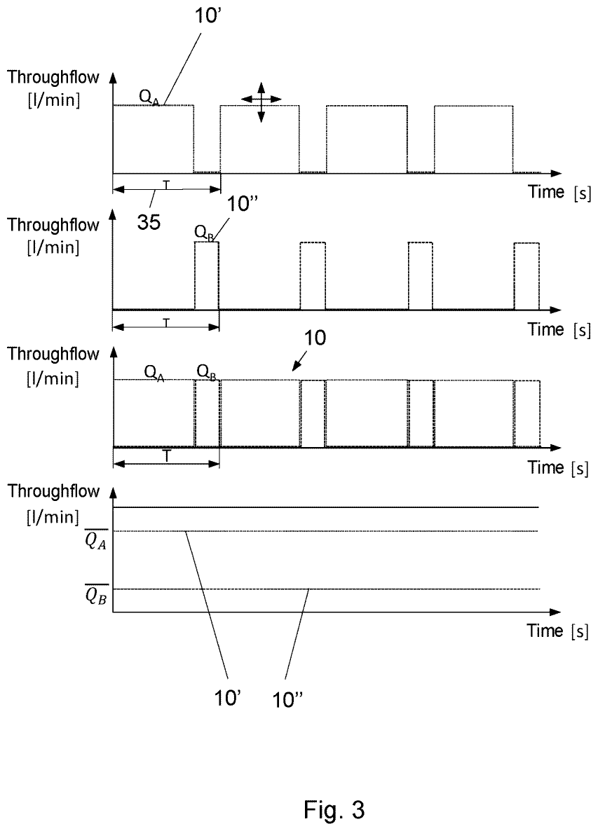

FIG. 3 shows by way of example a qualitative progression of the throughflow over time of the partial volume flows 10 which can be controlled in intermittent reverse operation by modulation of the rotational speed in the first direction of rotation 27, in the second direction of rotation 28, and the underlying period 35. The volume flows QA and QB can be modulated as desired on the time line. Because of the inertia which is created by thermal processes, as a function of the thermal masses, the influence of the period 35 is almost negligible and constant partial volume flows 10′, 10″ result over time.

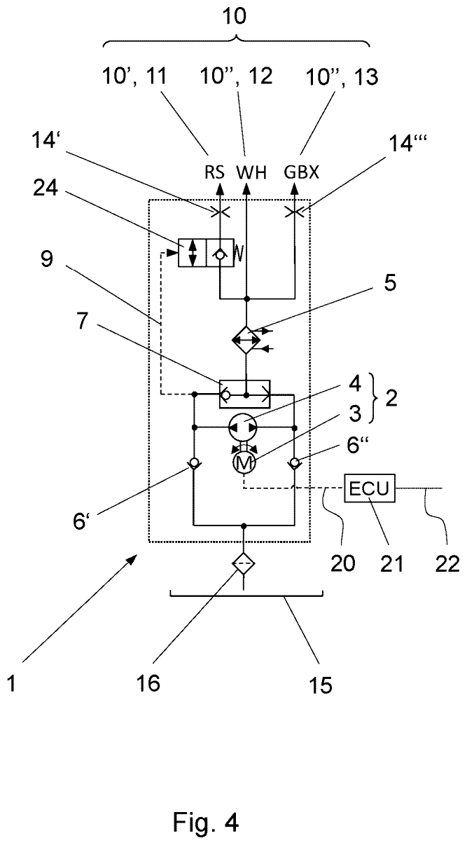

FIG. 4 shows the hydraulic circuit diagram of a second embodiment of the arrangement 1 with the motor pump unit 2 and the stop valve arrangement. Hydraulically controllable switching valves 24 are configured by a 2/2-way valve, configured as a seat valve.

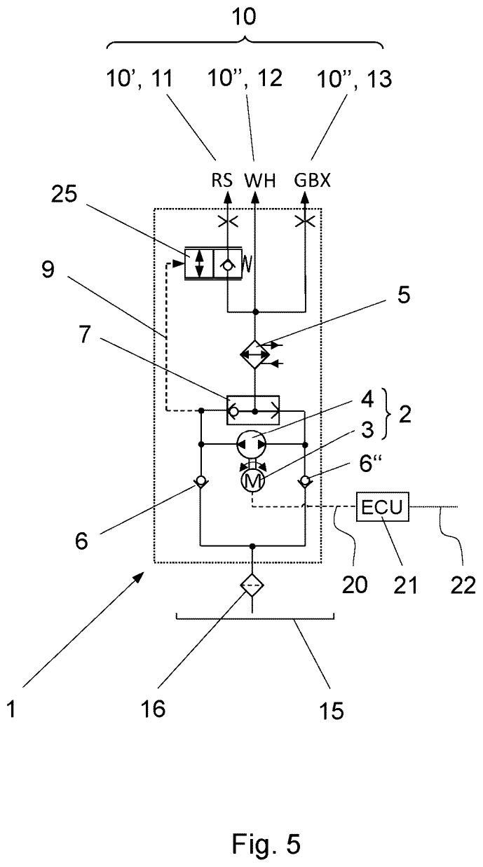

FIG. 5 shows the hydraulic circuit diagram of a third embodiment of the arrangement 1 with the motor pump unit 2 and the stop valve arrangement. The hydraulic stop valve is here configured by a hydraulically controlled 2/2-way proportional valve. This makes it possible, compared with the embodiments illustrated in FIG. 1 and in FIG. 4, to influence the distribution of the partial volume flows additionally via the control pressure and thus via the pump speed of the pump 4.

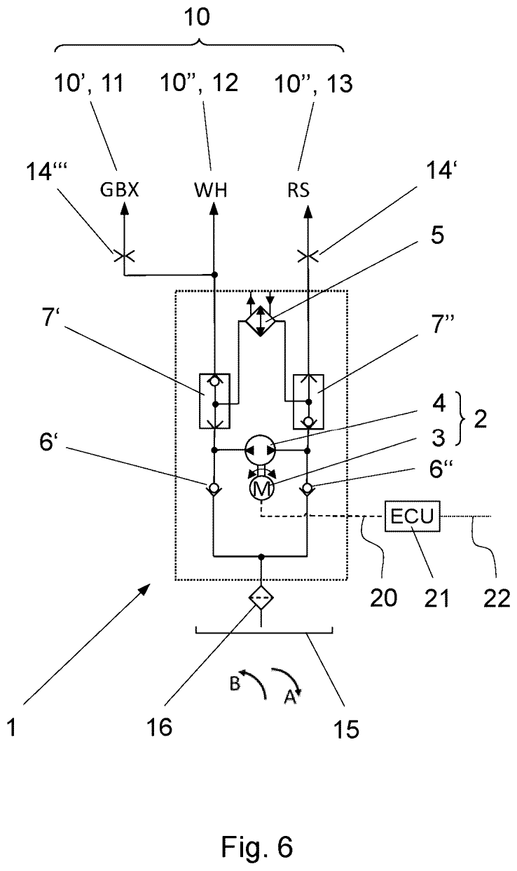

FIG. 6 shows the hydraulic circuit diagram of a fourth embodiment of the arrangement 1 with the motor pump unit 2 and the stop valve arrangement. An additional control line and a stop valve controlled hydraulically by means of a control piston 17 can be omitted here. The whole delivered flow is in turn routed via the heat exchanger 5. The latter is connected to the respective suction and discharge side of the pump 3 in each case via a first shuttle valve 7′ and a second shuttle valve 7″. In contrast to the embodiments above, the flow through the heat exchanger 5 is in different directions in the two directions of rotation of the pump. For example, there is a countercurrent flow of the volume flow delivered by the pump through the heat exchanger in the first direction of rotation A and a cocurrent flow through the heat exchanger in the second direction of rotation B.

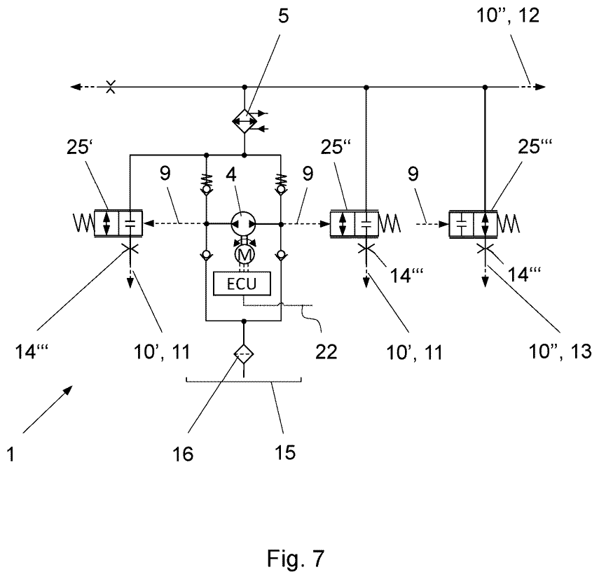

FIG. 7 shows the hydraulic circuit diagram of a further embodiment for the requirement-based distribution of cooling/lubricating oil flows. In order to extend the functional scope, two additional hydraulically controlled proportional valves 25″ and 25′″ are used here. The proportional valve 25′ controlled hydraulically via a control line 9 supplies an uncooled partial volume flow to the transmission. As a result, in particular in the cold state, the transmission sump temperature can be raised quickly and the efficiency increased. The remaining volume flow of the pump flows through the heat exchanger and is allocated via further proportional valves which are activated in each case via a hydraulic control line 9. A partial volume flow 11 is also routed to the transmission via the proportional valve 25″, wherein this partial volume flow is used for cooling purposes. A partial volume flow 13 is routed to the rotor shaft via the proportional valve 25′″.

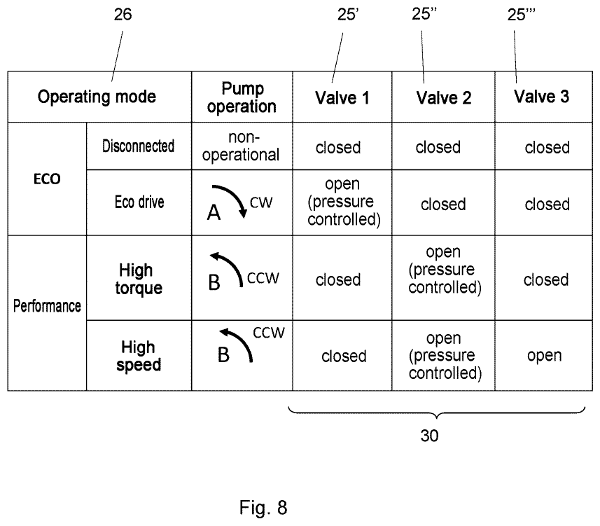

FIG. 8 shows the operating modes 26 which can be implemented with the arrangement illustrated in FIG. 7 and the associated valve positions 30 of the hydraulically controlled proportional valves 25′, 25″, and 25′″.

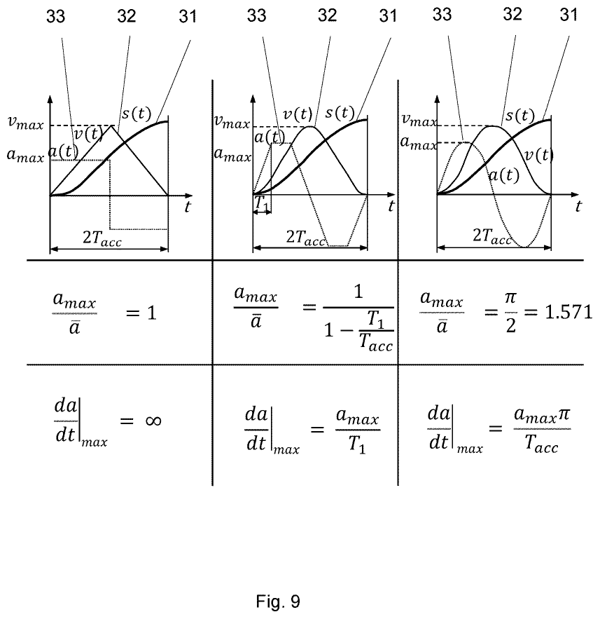

FIG. 9 shows a qualitative illustration of the values which are relevant for the reversal of the direction of rotation in the reversing procedure, specifically the angle of rotation 31 s(t), the angular velocity 32, v(t), and the angular acceleration 33, a(t) plotted against time t.

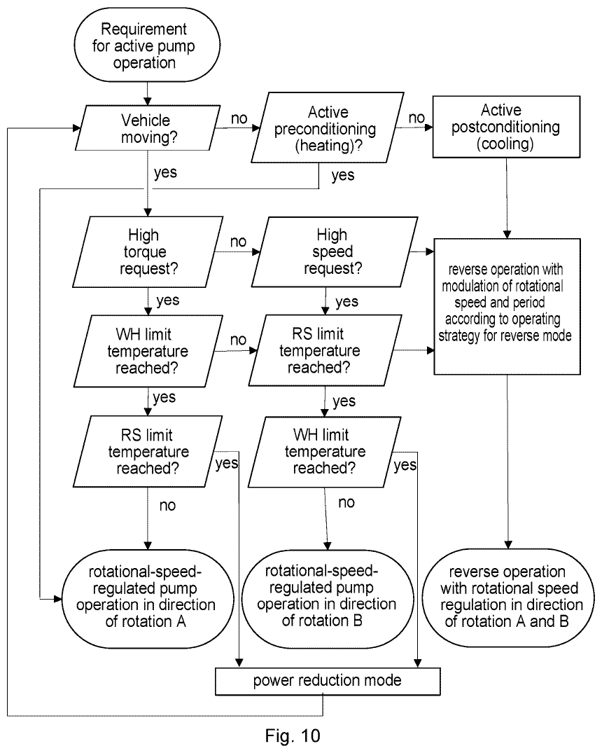

FIG. 10 shows by way of example a method for the requirement-based distribution of cooling/lubricating oil flows in an electric traction drive with an arrangement according to the invention according to the Figures above. A distinction is made here between rotational-speed-regulated operation in a first direction of rotation A or in a second direction of rotation B and intermittent reverse operation in the direction of rotation A and B. In the flow chart, a query is first made as to whether the vehicle is moving. If the answer to this query is positive, a check is made of the torque. If there is a high torque or if a high torque is to be set, a query is made as to whether the limit temperature at the stator or the stator windings WH has been reached. If the limit temperature has been reached, a query is made as to whether the limit temperature of the rotor RS of the electric machine has been reached. If this is not the case, the rotational-speed-regulated pump operation in the direction of rotation A is set. If both limit temperatures have been reached or exceeded, power reduction operation is set. With the vehicle moving, a high speed can also be requested. Here too, the limit temperatures are queried again, wherein first their limit temperature of the motor and then the limit temperature of the stator windings are queried. If the temperatures are within the predetermined range, rotational-speed-regulated operation in the direction of rotation B is initiated here.

If, when the limit temperatures are queried, they are in each case still below threshold values, reverse operation with modulation of the rotational speed duration according to the operating strategy is invoked both in the branch of the high torque request and in the branch of the high speed request. If the vehicle is to be actively preconditioned when stationary, rotational-speed-regulated pump operation in the direction of rotation A is set immediately.

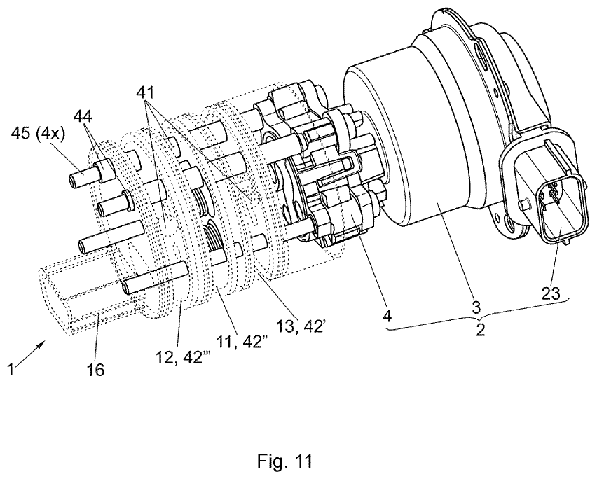

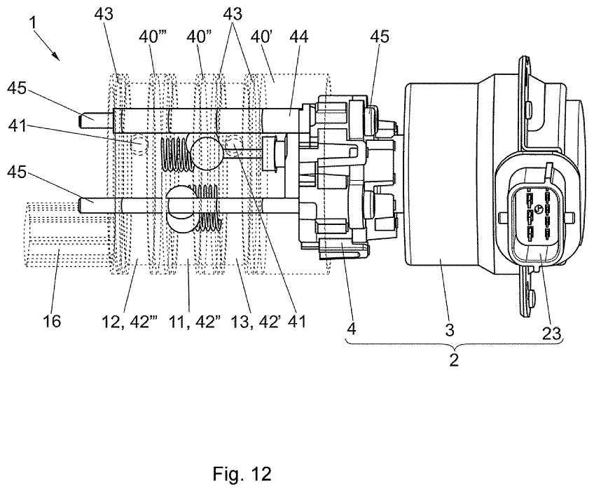

FIG. 11 shows an isometric view of an embodiment of the arrangement illustrated in FIG. 1 for requirement-based distribution of cooling/lubricating oil flows. The electrically controllable motor pump unit 2, which consists of the electric motor 3 and the cooling/lubricating oil pump 4, is illustrated on the right-hand side of FIG. 11 and FIG. 12. An electrical plug 23 enables electrical connection. The housing of the hydraulic components consists of housing plates 40′, 40″, 40′″ and has a multi-part construction. The individual housing plates 40′, 40″, 40′″ are screwed to one another via screws 45 and associated adapter sleeves 44.

By virtue of the multi-part configuration of the housing, with housing plates fixed relative to one another via adapter sleeves 44 and screws 45, cost-effective manufacture and mounting as well as easy industrializability can be achieved. The housing plates are here configured as sintered parts or injection-molded plastic parts. The connection of the housing plates 40′, 40″, 40′″ can optionally be effected by other form-fitting, frictional, or materially bonded connection techniques, specifically by interlocking, clip-fastening, grouting, adhesive bonding, or welding. Connection of the housing plates 40′, 40″, 40′″ via bayonet catches is also possible. The respective partial volume flows 10′, 10″, 10′″ are routed to the outside via radially arranged bores 41 opening into peripheral annular grooves 42′, 42″, 42′″. The seal between the annular grooves is made via O-rings 43. The housing plates 40′, 40″, and 40′″ can, in order to avoid internal oil leaks, optionally be sealed with respect to one another via paper seals or other soft-sealing sealing elements. When they are configured as sintered parts with surface-ground end faces, additional sealing can be dispensed with.

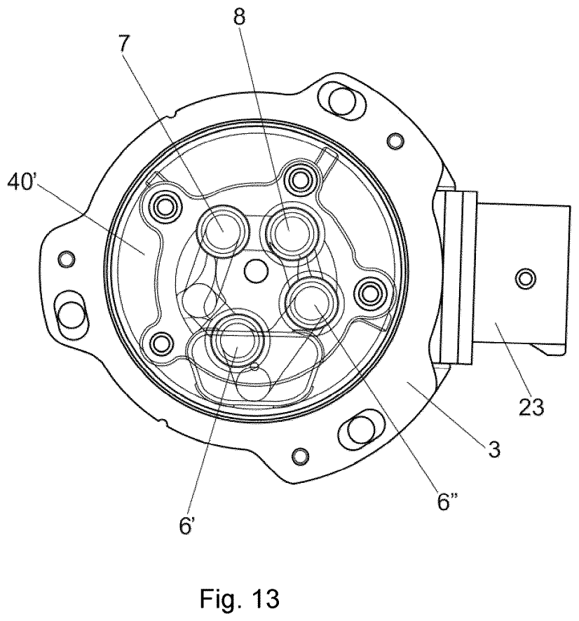

FIG. 13 shows a front view of the embodiment according to FIGS. 11 and 12 with a view of the housing plate 40′ with the two nonreturn valves 6′, 6″. The shuttle valve 7 and the hydraulically controllable stop valve 8 are also installed in this housing plate 40′.

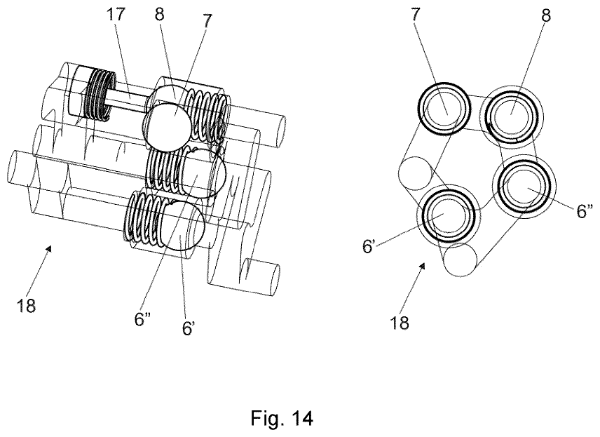

FIG. 14 shows, in order to illustrate the hydraulic flow path, the corresponding negative geometry 18 of the embodiment illustrated in FIGS. 11-13. Illustrated again are the two nonreturn valves 6′, 6″ as well as the shuttle valve 7 and the hydraulically controllable stop valve 8 with its control piston 17.

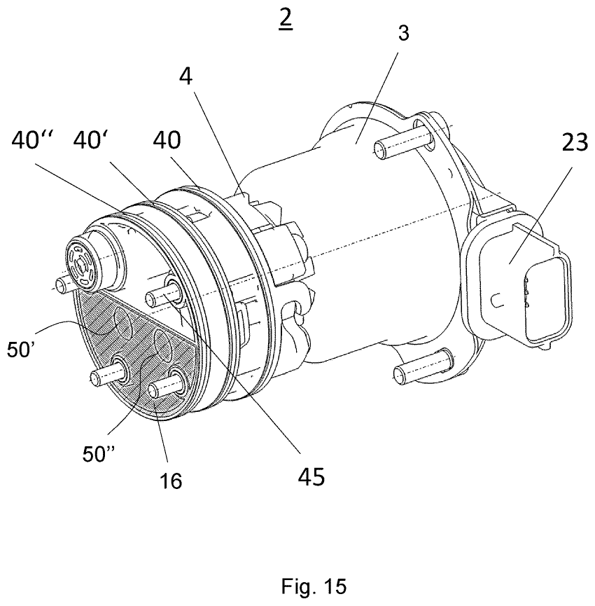

FIG. 15 shows an isometric view of a second embodiment of the arrangement illustrated in FIG. 1 for requirement-based distribution of cooling/lubricating oil flows with a two-part housing configuration. Indicated on the right-hand side of FIG. 15 is the electrically controllable motor pump unit 2 which consists of the electric motor 3 and the cooling/lubricating oil pump 4. An electrical plug 23 enables electrical connection.

The housing of the hydraulic components consists of housing plates 40′, 40″, 40″ and has a multi-part construction. The individual housing plates 40′, 40″, 40″ are screwed to one another via screws 45 and associated adapter sleeves 44.

The connection of the housing plates 40′, 40″, 40″ can optionally be effected by other form-fitting, frictional, or materially bonded connection techniques, specifically by interlocking, clip-fastening, grouting, adhesive bonding, or welding. Connection of the housing plates 40′, 40″, 40′″ via bayonet catches is also possible. The respective partial volume flows 10′, 10″, 10′″ are routed to the outside via radially arranged bores 41 opening into peripheral annular grooves 42′, 42″, 42′″. The seal between the annular grooves is made via O-rings 43. The housing plates 40′, 40″, and 40′″ can, in order to avoid internal oil leaks, optionally be sealed with respect to one another via paper seals or other soft-sealing sealing elements. When they are configured as sintered parts with surface-ground end faces, additional sealing can be dispensed with.

The suction is effected—depending on the direction of rotation of the electric motor 3—via in each case one inlet valve 50′ or 50″ arranged behind a filter sieve 16 integrated at the end side.

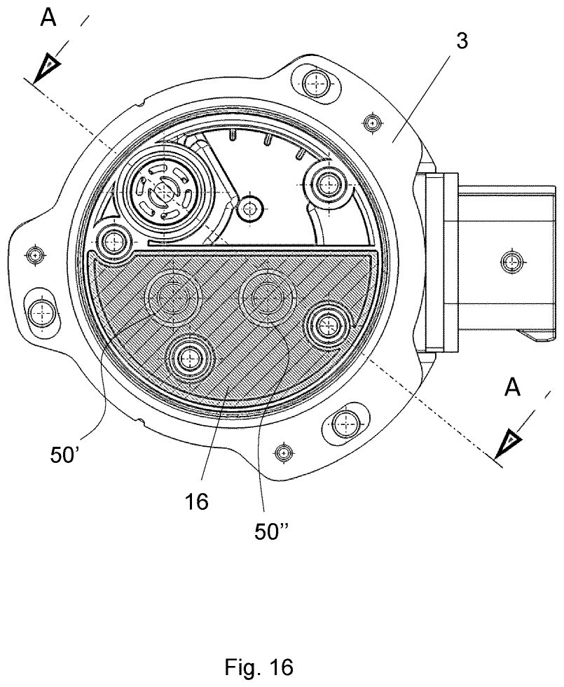

FIG. 16 shows a front view of the embodiment illustrated in FIG. 15 for the requirement-based distribution of cooling/lubricating oil flows with a view of the filter sieve 16 and the two inlet valves 50′ and 50″.

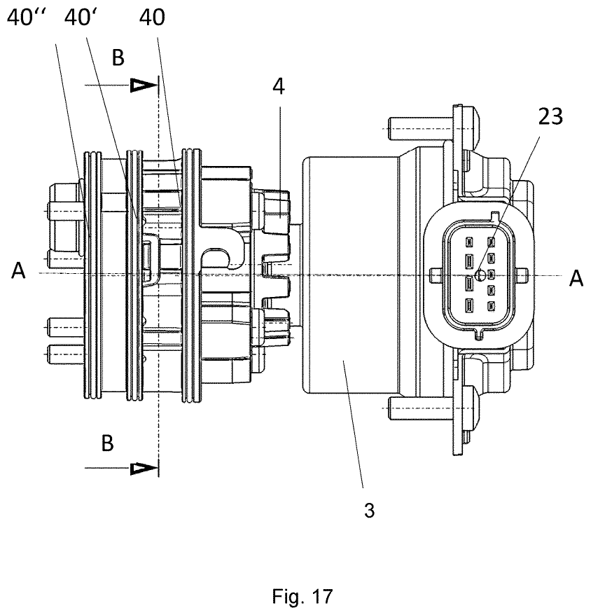

FIG. 17 shows a side view of the embodiment illustrated in FIG. 15 for the requirement-based distribution of cooling/lubricating oil flows.

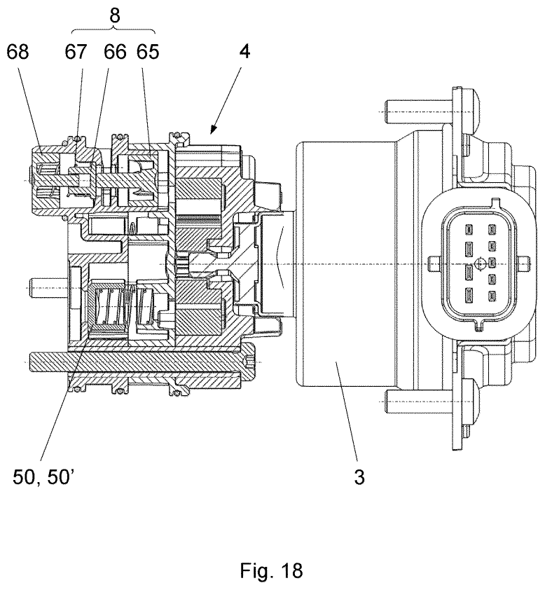

FIG. 18 shows a view in section along the plane of section A-A illustrated in FIG. 16. The stop valve 8 can be seen in the sectional view. It is constructed with a control piston 65 with a valve spring 67 and a stop function 66 and is closed with an end cap 68.

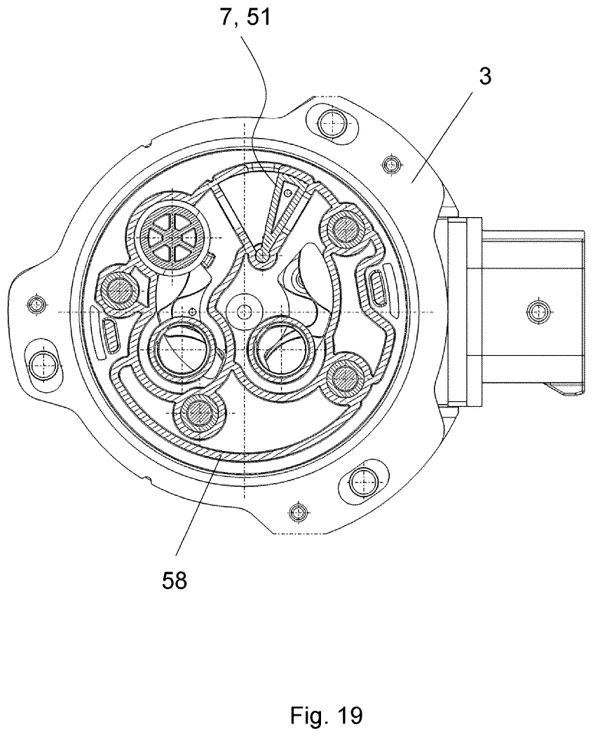

FIG. 19 shows a view in section along the plane of section B-B illustrated in FIG. 17. The shuttle valve 58 is designed here in a valve housing 58 as a swivel flap valve 51.

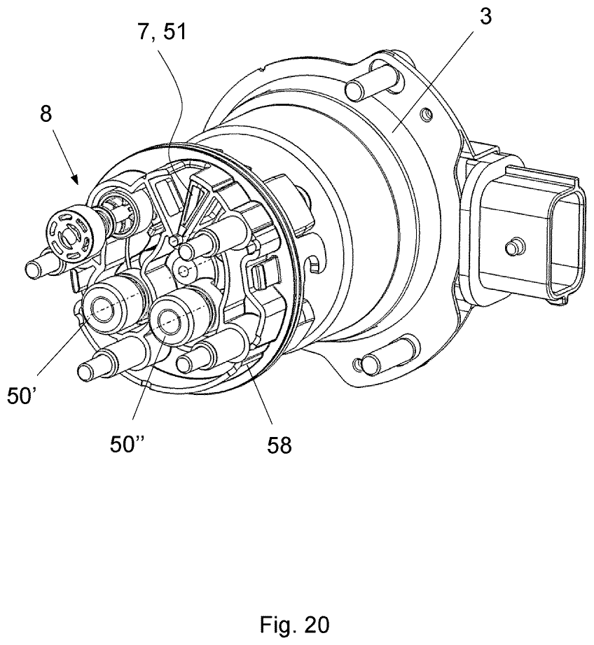

FIG. 20 shows an isometric view of the embodiment illustrated in FIG. 15 for the requirement-based distribution of cooling/lubricating oil flows with a hidden second housing plate 40″. Visible in the valve housing 58 in this illustration are, in addition to the inlet valves 50′, 50″, the shuttle valve 7 configured as a swivel flap valve 51 and the stop valve 8 which is hydraulically actuatable via the control piston 65.

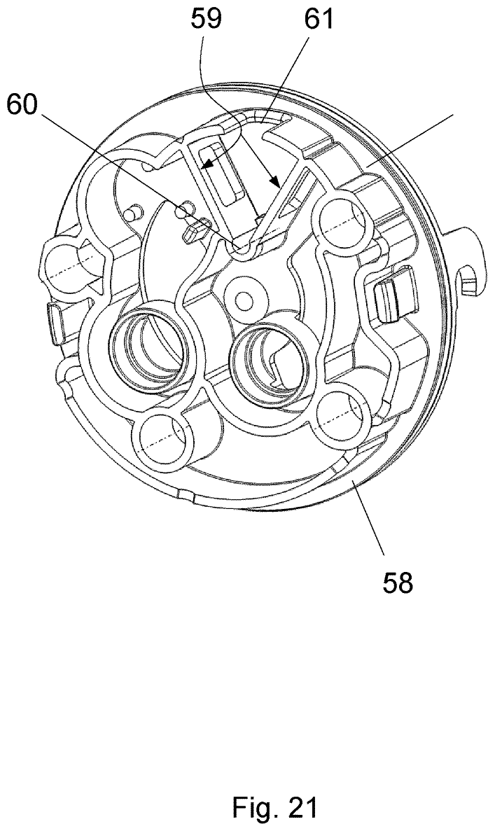

FIG. 21 shows an isometric view of the first housing plate 40′receptacles for the shuttle valve 7. Present symmetrically with respect to the outlet opening 61 of the shuttle valve 7 are sealing faces 59 arranged on both sides in a wedge shape and extending along the longitudinal axis of the arrangement 1. The sealing faces 59 taper toward a bearing shell 60 configured to guide a bearing pin 53. The bearing shell 60 defines an associated pivot axis 52. By virtue of the configuration according to the invention of the swivel flap valve 51, the mounting of the swivel flap valve via the bearing shell 60, as well as the functionally relevant sealing faces 59, can be illustrated at only one housing part, the valve housing 58. The influence of manufacturing tolerances can consequently be minimized.

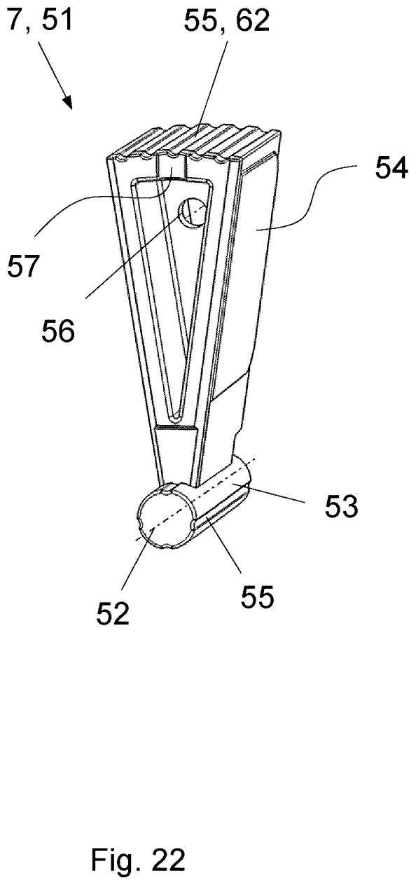

FIG. 22 shows an isometric view of a part of the shuttle valve 7 configured as a swivel flap valve 51 with sealing faces 54 which are arranged on both sides and can bear against the sealing faces 59 of the valve housing 58. The shuttle valve 7 is moved in the region of a bearing pin 53 and can pivot about the pivot axis 52. The part is configured as a wedge-shaped part with a periphery 62 in the shape of a segment of a circle. Dirt-trapping grooves 55 arranged at the outer periphery 62 in the shape of a segment of a circle and in the region of the bearing pin 53 make it possible to hold particles of dirt penetrating the region of the bearing and sealing points and thus reduce the risk of jamming. A connecting bore 56 arranged in an axial direction, as well as a pressure-relieving groove 57 introduced on at least one side of the swivel flap valve 51 enable equalization of pressure between the end sides of the swivel flap valve 51 and the outlet opening 61 arranged in the first housing plate 40′.

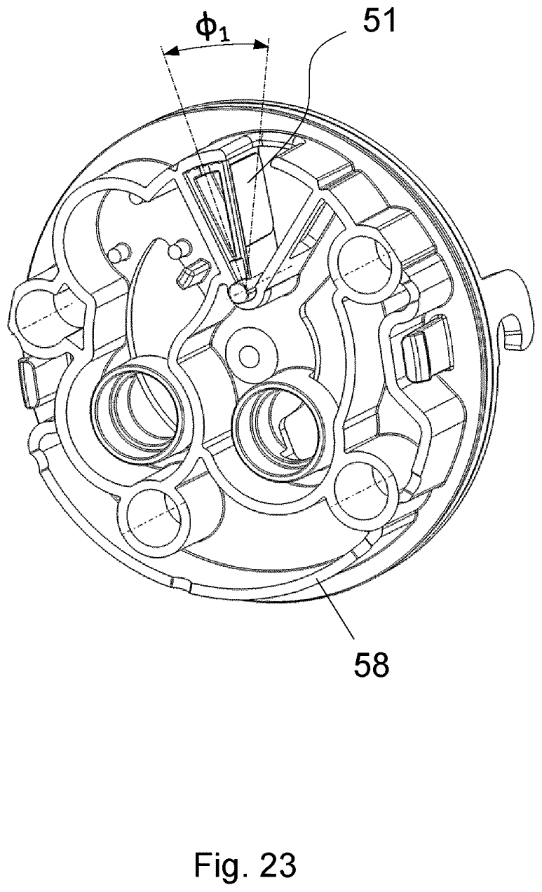

FIG. 23 shows an isometric view of the first housing plate 40′ with the swivel flap valve 51 according to the invention in a first angular position Φ1.

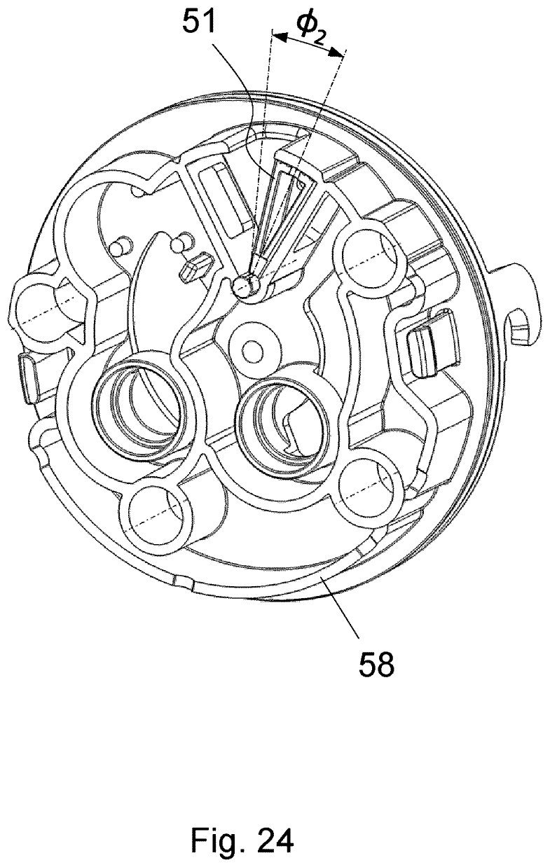

FIG. 24 shows an isometric view of the first housing plate 40′ with the swivel flap valve 51 according to the invention in a second angular position Φ2.

### LIST OF REFERENCE SIGNS

1 arrangement for requirement-based control of partial volume flows
2 electrically controllable motor pump unit
3 electric motor
4 cooling/lubricating oil pump
5 heat exchanger
6 nonreturn valve
6′ first nonreturn valve
6″ second nonreturn valve
7 shuttle valve
7′ first shuttle valve
7″ second shuttle valve
8 hydraulically controllable stop valve
9 hydraulic control line
10 partial volume flows
10′ first partial volume flow
10″ second partial volume flow
10′″ third partial volume flow
11 partial volume flow to the rotor/rotor shaft
12 partial volume flow to the stator/winding heads
13 partial volume flow to the transmission
14 14′ 14″ 14′″ diaphragm
15 oil sump
16 sieve/filter element
17 control piston
18 negative geometry of the flow path
20 electrical line
21 electrical control unit
22 data bus
23 plug
24 hydraulically controllable switching valve
25 25′ 25″ 25′″ hydraulically controllable proportional valve
26 operating mode
27 first direction of rotation or direction of rotation A
28 second direction of rotation or direction of rotation B
29 reverse operation
30 valve position
31 angle of rotation
32 angular velocity
33 angular acceleration
34 jump
35 period
40, 40′, 40″ 40′″ housing plate
41 outlet bore
42 42′ 42″ 42′″ annular groove
43 O-ring
44 adapter sleeve
45 screw
50 inlet valve
50′ first inlet valve
50″ second inlet valve
51 swivel flap valve
52 pivot axis
53 bearing pin
54 sealing face
55 dirt-trapping grooves
56 connecting bore
57 pressure-relieving groove
58 valve housing
59 sealing face
60 bearing shell
61 outlet opening
62 periphery in the shape of a segment of a circle
65 control piston
66 stop valve
67 valve spring
68 end cap
Φ1 first angular position
Φ2 second angular position

1. An arrangement for requirement-based distribution of cooling/lubricating oil flows in electric traction drives with an electrically controllable motor pump unit and a hydraulic arrangement, wherein the motor pump unit can be activated in both directions of rotation, and wherein the motor pump unit is connected via a heat exchanger to a plurality of fluid outlets for partial volume flows which are connected at least to the stator of an electric machine, to the rotor of an electric machine, and to the transmission for cooling and/or heating and/or lubrication purposes, wherein at least one fluid outlet is additionally opened via at least one hydraulically switchable valve when a reversal of the direction of rotation of the motor pump unit takes place.

2. The arrangement as claimed in claim 1, wherein partial volume flows are available for the electric traction drive via the fluid outlets, wherein the partial volume flow to the stator or to the winding heads of the stator comprises the majority of the volume flow.

3. The arrangement as claimed in claim 1, wherein presetting of the partial volume flows is effected via diaphragms.

4. The arrangement as claimed in claim 1, wherein the hydraulically switchable valve is a hydraulically controllable stop valve or a hydraulically controllable proportional valve or a hydraulically controllable switching valve.

5. The arrangement as claimed in claim 1, wherein at least one shuttle valve connects the respective suction and discharge side of the pump.

6. The arrangement as claimed in claim 5, wherein the shuttle valve is a swivel flap valve.

7. The arrangement as claimed in claim 1, wherein the hydraulic arrangement is constructed from a plurality of housing plates, wherein the housing plates carry in each case at least one functional unit.

8. The arrangement as claimed in claim 7, wherein the housing plates are screwed to one another and to the cooling/lubricating oil pump.

9. The arrangement as claimed in claim 7, wherein the functional units comprise at least one of the valves and/or radially arranged bores opening into peripheral annular grooves.

10. A method for requirement-based distribution of cooling/lubricating oil flows in electric traction drives with an electrically controllable motor pump unit and a hydraulic arrangement, wherein the motor pump unit is activated in both directions of rotation, and wherein the motor pump unit is connected via a heat exchanger to a plurality of fluid outlets which are connected at least to the stator of an electric machine, and/or to the rotor of an electric machine, and/or to the transmission for cooling and/or heating and/or lubrication purposes, wherein at least one fluid outlet is additionally opened via at least one hydraulically switchable valve when a reversal of the direction of rotation of the motor pump unit takes place.

11. The method as claimed in claim 10, wherein different operating modes are set in order to set the flow volume of the respective partial volume flows at the fluid outlets, wherein in a reverse-operation operating mode a switch is made cyclically between the directions of rotation of the motor pump unit over time.

12. The method as claimed in claim 10, wherein different operating modes from operation of the motor pump unit in a direction of rotation A or a direction of rotation B or in reverse operation can be set.

13. The method as claimed in claim 12, wherein additional rotational-speed-dependent activation of the motor pump unit is provided.

14. The arrangement as claimed in claim 2, wherein presetting of the partial volume flows is effected via diaphragms.

15. The arrangement as claimed in claim 8, wherein the functional units comprise at least one of the valves and/or radially arranged bores opening into peripheral annular grooves.

16. The method as claimed in claim 10, wherein different operating modes from operation of the motor pump unit in a direction of rotation A or a direction of rotation B or in reverse operation can be set.

17. The method as claimed in claim 11, wherein different operating modes from operation of the motor pump unit in a direction of rotation A or a direction of rotation B or in reverse operation can be set.

18. The arrangement as claimed in claim 2, wherein the hydraulically switchable valve is a hydraulically controllable stop valve or a hydraulically controllable proportional valve or a hydraulically controllable switching valve.

19. The arrangement as claimed in claim 3, wherein the hydraulically switchable valve is a hydraulically controllable stop valve or a hydraulically controllable proportional valve or a hydraulically controllable switching valve.

20. The arrangement as claimed in claim 2, wherein at least one shuttle valve connects the respective suction and discharge side of the pump.
